(19) United States
(12) Patent Application Publication
(10) Pub. No.: US 2008/0236676 A1
(43) Pub. Date: Oct. 2, 2008

(54) Fuel feed apparatus

(75) Inventors: Tatsuya Matsumoto, Kariya-city (JP); Tomohiro Ishihara, Okazaki-city (JP); Kazunori Ikubo, Nagoya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/076,060

(22) Filed: Mar. 13, 2008

(30) Foreign Application Priority Data
Mar. 29, 2007 (JP) 2007-88766

(51) Int. Cl. F16K 31/18

(52) U.S. Cl. 137/409

(57) ABSTRACT

A fuel feed apparatus includes a sub-tank that is received in the fuel tank, a fuel pump received in the sub-tank and pumps up and pressurizes fuel in the sub-tank for supplying the fuel to the outside of the fuel tank, a jet pump disposed to supply fuel in the fuel tank into the sub-tank, and a recirculation passage defined in the sub-tank and communicating between the inside and the outside of the sub-tank. The jet pump includes a suction port to communicate between the inside and the outside of the sub-tank and a jet nozzle that jets fuel toward the suction port, so as to generate suction power by which fuel in the fuel tank is suctioned from the first suction port into the sub-tank. Moreover, the recirculation passage that opens at a lower edge thereof close to the upstream side of the suction port of the jet pump and opens at an upper edge thereof below the upper edge of a sidewall of the sub-tank.

### CROSS REFERENCE TO RELATED APPLICATION

This application is based upon, claims priority from and incorporates herein by reference the contents of Japanese Patent Application No. 2007-88766 filed on Mar. 29, 2007.

### FIELD OF THE INVENTION

The present invention relates to a fuel feed apparatus that supplies fuel in a fuel tank to the outside of the fuel tank.

### BACKGROUND OF THE INVENTION

A fuel feed apparatus disclosed in JP-A-2004-316567 includes a sub-tank received in a fuel tank, a fuel pump received in the sub-tank to supply fuel in the fuel tank to the outside of the fuel tank (e.g. an internal combustion engine) through the sub-tank, and a jet pump to supply fuel in the fuel tank into the sub-tank. The fuel pressurized by the fuel pump is partially supplied to the jet pump so that the jet pump operates thereby.

Generally, the amount of flow discharged from the jet pump is larger than the amount of fuel supplied from the sub-tank to an internal combustion engine. Therefore, the sub-tank can be constantly filled with fuel. At the same time, excessive fuel overflows from the sub-tank to the fuel tank.

The fuel temperature in the sub-tank increases due to heat given off from operation of the electric motor disposed in the fuel pump to drive the fuel pump. In this case, the fuel temperature in the fuel tank increases because the fuel warmed by the heat generated by the electric motor overflows from the sub-tank to the fuel tank. The increase in fuel temperature in the fuel tank can increase the amount of fuel evaporation emission generated in the fuel tank.

### SUMMARY OF THE INVENTION

In view of the foregoing problem, it is an object of the present invention to provide an fuel feed apparatus that prevents or reduces fuel warmed by the heat in the sub-tank from overflowing to the fuel tank so as not to increase temperature of fuel in the fuel tank.

According to the present invention, a fuel feed apparatus includes a sub-tank that is received in the fuel tank, a fuel pump that is received in the sub-tank and pumps up and pressurizes fuel in the sub-tank for supplying the fuel to the outside of the fuel tank, a jet pump disposed to supply fuel in the fuel tank into the sub-tank, and a recirculation passage that is provided in the sub-tank and communicates between the inside and the outside of the sub-tank. The jet pump includes a suction port to communicate between the inside and the outside of the sub-tank and a jet nozzle that jets fuel toward the suction port, so as to generate suction power by which fuel in the fuel tank is suctioned through the suction port into the sub-tank. Moreover, the recirculation passage opens at a lower end thereof close to the upstream side of the suction port of the jet pump and opens at the upper end thereof below the upper edge of a sidewall of the sub-tank.

Alternatively, a fuel feed apparatus includes a cover that is fixed on the upper edge of the sub-tank to cover the sub-tank hermetically and a valve system that is disposed in the cover. The valve closes to prevent communication between the inside and the outside of the sub-tank when the sub-tank is filled with fuel.

Alternatively, a fuel feed apparatus includes a flange mounted on an upper wall of the fuel tank to cover an opening formed in the upper wall and supports the sub-tank, a flexible cover formed as a hollow-cylinder, having one end fixed on the upper edge of the sub-tank and the other end fixed on the flange and a communication hole formed at the upper side of the flexible cover near the flange to communicate between the inside and the outside of the flexible cover.

### BRIEF DESCRIPTION OF THE DRAWINGS

The above and other objects, features and advantages of the present invention will become more apparent from the following detailed description with reference to the accompanying drawings.

In the drawings:

FIG. 1 is a schematic cross-sectional view showing a fuel feed apparatus accommodated in a fuel tank according to a first embodiment of the present invention;

FIG. 2 is a top view from the direction II in FIG. 1;

FIG. 3 is a schematic cross-sectional view showing a fuel feed apparatus according to a second embodiment of the present invention;

FIG. 4 is a schematic cross-sectional view showing a fuel feed apparatus according to a third embodiment of the present invention; and

FIG. 5 is a schematic cross-sectional view showing a fuel feed apparatus according to a fourth embodiment of the present invention.

### DETAILED DESCRIPTION OF THE PREFERRED EMBODIMENTS

### First Embodiment

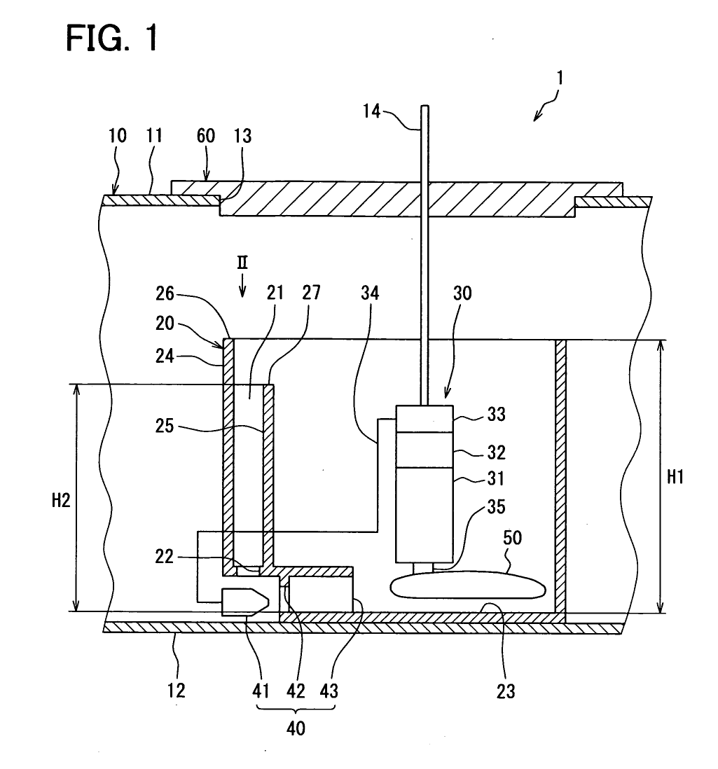

As shown in FIG. 1, a fuel feed apparatus 1 is received in a fuel tank 10 for transferring fuel in the fuel tank 10 to an exterior device, such as an internal combustion engine, provided outside of the fuel tank 10. The fuel feed apparatus 1 includes a sub-tank 20, a pump module 30, a jet pump 40, a suction filter 50, a flange 60, and the like.

The fuel tank 10 is formed by press forming of steel sheets or resin molding, etc. The fuel tank 10 has an opening 13 at the upper wall 11 of the fuel tank 10. The flange 60 of the fuel feed apparatus 1 is mounted on the upper wall 11, so as to cover the opening 13. The opening 13 and flange 60 are circular in shape.

The sub-tank 20 is received in the fuel tank 10, as shown FIG. 1. For example, the sub-tank 20 is made of resin and is formed in a bottomed cylindrical shape. Shafts (not shown) are fixed with the flange 60 at one end, and are slidably inserted into insertion sections (not shown) formed in the sub-tank 20. Springs (not shown) are provided around the shafts so that the flange 60 and the sub-tank 20 are biased apart from each other. Expansion and shrinkage may arise in the fuel tank 10, as the inner pressure of the fuel tank 10 varies. The inner pressure of the fuel tank 10 varies due to a temperature variation or a variation in the amount of fuel contained in the fuel tank 10. Even if expansion or shrinkage arises in the fuel tank 10, the bottom wall 23 of the sub-tank 20 is held pressed onto the bottom wall 12 of the fuel tank 10 by the force of the springs.

The pump module 30 is received in the sub-tank 20. The pump module 30 includes a pump section 31, a fuel filter 32 and a pressure regulator 33. The pump section 31 pumps up and pressurizes fuel for supplying the fuel from the fuel tank 10 to the internal combustion engine. The fuel filter 32 collects debris, which is contained in fuel discharged from the pump section 31. The pressure regulator 33 controls the pressure of the fuel discharged from the pump section 31 to adjust the pressure of the discharged fuel to a predetermined pressure. Generally, the pressure of fuel discharging from the pump section 31 is set higher than fuel pressure supplied to the engine, that is, fuel pressure in a supply pipe 14. Thus, fuel discharged from the pump section 31 is partially discharged into the sub-tank 20 through the pressure regulator 33 and a return pipe 34, so as to adjust the pressure of the fuel supplied through the supply pipe 14 to the predetermined pressure. Therefore, fuel is discharged constantly from the pressure regulator 33 through the return pipe 34. Fuel that is adjusted to the predetermined pressure by the pressure regulator 33 is supplied to the outside of the fuel tank 10, e.g. the engine, through the supply pipe 14.

A suction filter 50 is connected to a suction port 35 of the pump section 31, as shown in FIG. 1. The suction filter 50 removes debris included in the fuel.

The jet pump 40 is disposed in or adjacent the sub-tank 20 to supply fuel in the fuel tank 10 into the sub-tank 20. The jet pump 40 includes an inlet port 41, a suction port 42 and a discharge port 43. The inlet port 41 is connected to the return pipe 34. Thus, fuel discharged from the pressure regulator 33 flows into jet pump 40 through the inlet port 41. Moreover, the jet pump 40 includes a jet nozzle (not shown). For example, the jet pump is arranged at the downstream side of the inlet port 41. The jet nozzle 40 is communicated with the suction port 42. When fuel flows out through the jet nozzle from the inlet port 41 toward the suction port 42, suction power is generated within the jet pump 40. Fuel in the fuel tank 10 is suctioned by the suction power from the suction port 42 to the sub-tank 20 through the discharge port 43. Specifically, both the fuel flowing from the inlet port 41 and the fuel suctioned from the fuel tank 10 are supplied into the sub-tank 20 through discharge port 43. With the above structure, the jet pump 40 is driven by fuel discharged from the pump module 30. Therefore, another pump module or fuel pump for driving the jet pump 40 does not need to be provided in the fuel feed apparatus 1.

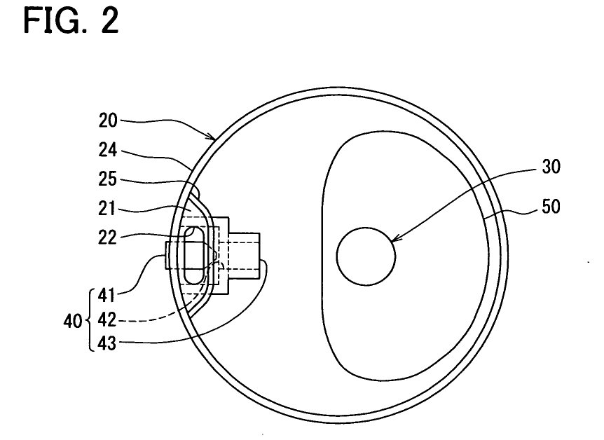

The sub-tank 20 is divided by a partition wall 25, as shown in FIG. 2. The partition wall 25 is connected integrally with the sidewall 24 of the sub-tank 20 by integral molding. With this structure, a recirculation passage 21 is formed within the sub-tank 20 which is a space enclosed by the sidewall 24 and the partition wall 25. A communication hole 22 is formed at the axially lower end of the recirculation passage 21. The communication hole 22 opens close by the upstream side of the suction port 42, as shown in FIG. 1. The height H2 of an upper edge 27 of the partition wall 25 is set lower than the height H1 of an upper edge 26 of the sidewall 24 of the sub-tank 20 with respect to the bottom wall 23 of the sub-tank 20. Therefore, the upper end 27 of the recirculation passage 21 opens below the upper edge 26 of the sidewall 24, that is, it opens within the sub-tank 20.

When the fuel feed apparatus 1 is in operation (when the engine is in operation), fuel in the fuel tank 10 is supplied to the sub-tank 20 with the jet pump 40. At the same time, fuel in the sub-tank 20 is supplied to the engine through the supply pipe 14 with the pump module 30. Generally, the amount of fuel discharging from the jet pump 40 is set more than the maximum amount of fuel supplied to the engine. Accordingly, the sub-tank 20 can be constantly filled with fuel when the fuel feed apparatus 1 is in operation.

In the first embodiment, when the fuel level in the sub-tank 20 rises above the upper end 27 of the recirculation passage 21, fuel in the sub-tank 20 flows into the recirculation passage 21 from the upper opening of the recirculation passage 21. The fuel that flowed into the recirculation passage 21 flows out of the recirculation passage 21 through the communication hole 22. The fuel that flows out of the recirculation passage 21 is suctioned to the suction port 42 and flows into the sub-tank 20 again without flowing throughout the fuel tank 10.

Generally, a fuel pump driven by a motor (not shown) is used as the pump section 31 of the pump module 30. Fuel temperature in the sub-tank 20 increases because the motor generates heat when the motor is in operation. With the above-described fuel feed apparatus 1, fuel in the sub-tank 20 does not flow throughout the fuel tank 10. In other words, fuel feed apparatus 1 can prevent fuel warmed by the heat generated from the motor from flowing throughout the fuel tank 10. Accordingly, fuel feed apparatus 1 can prevent the fuel temperature in the fuel tank 10 from increasing.

In the first embodiment, the upper end 27 of the recirculation passage 21 opens below the upper edge 26 of the sidewall 24, that is, it opens within the sub-tank 20. With this structure, fuel in the sub-tank 20 flows surely into the recirculation passage 21 before overflowing from the upper edge 26 of the sub-tank 20 into the fuel tank 10. Accordingly, this structure can prevent fuel warmed by the heat generated by the motor from flowing throughout the fuel tank 10.

### Second Embodiment

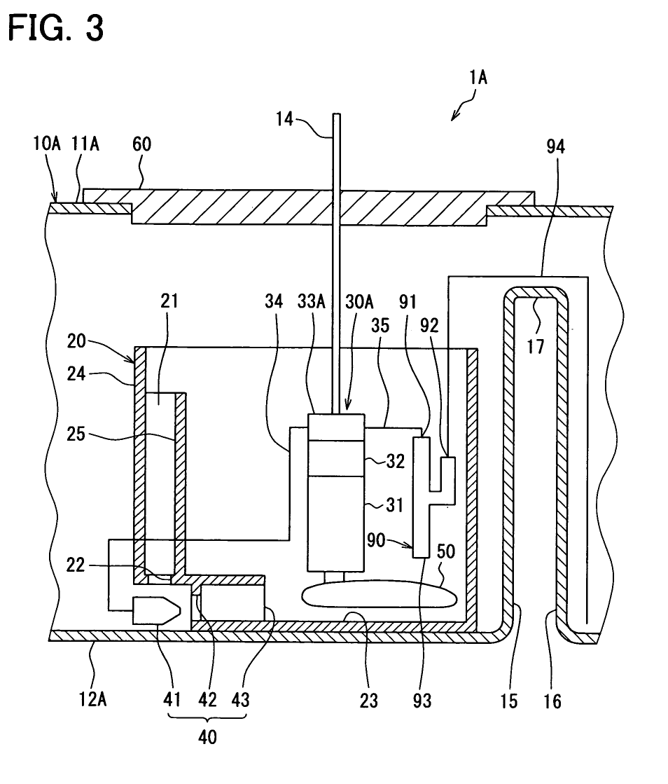

A fuel feed apparatus according to the second embodiment will be described with reference to FIG. 3. The same or similar reference numerals hereafter indicate the same or substantially the same part, portion or component as the first embodiment.

As shown in FIG. 3, a fuel tank 10A is a saddle-shaped fuel tank that includes a first tank section 15, a second tank section 16, and a connecting portion 17 connecting the first tank section 15 with the second tank section 16. The first tank section 15 is communicated with the second tank section 16 through the connecting portion 17. A fuel feed apparatus 1A is received in the first tank section 15. Moreover, a jet pump 90 is disposed in the sub-tank 20. An inlet port 91 of the jet pump 90 is connected with the pressure regulator 33A of the pump module 30A by using a return pipe 35. Fuel discharged from the pressure regulator 33A is partially supplied to the inlet port 91 through the return pipe 35. A suction port 92 of the jet pump 90 is connected with one end of a transfer pipe 94. The other end of the transfer pipe 94 is positioned near a bottom wall of the second tank section 16, as shown in FIG. 3.

When fuel flows into the inlet port 91 of the jet pump 90 from the pump module 30A through the return pipe 35, suction power is generated within the suction port 92 of the jet pump 90. Fuel in the second tank section 16 is suctioned by the suction power and fuel in the second tank section 16 flows into the sub-tank 20 through the transfer pipe 94 and the jet pump 90.

The other structural features are the same as those described in the first embodiment. Accordingly, the fuel feed apparatus described in the second embodiment has the same advantages as the one described in the first embodiment.

### Third Embodiment

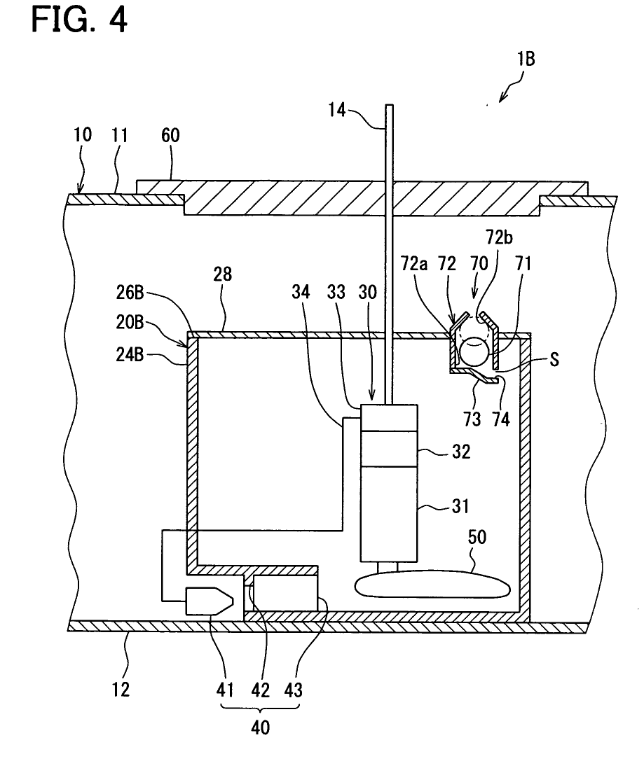

A fuel feed apparatus according to the third embodiment will be described with reference to FIG. 4.

As shown in FIG. 4, a fuel feed apparatus 1B does not include a recirculation passage and a communication hole. Instead, the fuel feed apparatus 1B includes a cover 28 and a ventilation valve 70. The cover 28 is made of resin, for example. The other structural features, a pump module 30, a jet pump 40 and a suction filter 50, are the same as the ones described in the first embodiment.

The cover 28 is fixed on the upper edge 26B of the sub-tank 20B to hermetically cover the sub-tank 20B. With this structure, fuel in the sub-tank 20B does not overflow from the upper edge 26B of the sub-tank 20B to the fuel tank 10, even when the sub-tank 20B is filled with fuel.

The ventilation valve 70 is disposed in the cover 28. The ventilation valve 70 includes a valve element 71, a housing 72, and a lid member 73. The valve element 71 is made of material whose specific gravity is lower than that of fuel, for example, resin, so that it floats on fuel, and it is formed as a spherical body. The valve element 71 is accommodated in the housing 72 and is movable in the axial direction of the sub-tank 20B.

The housing is made of resin, for example, and includes a cylindrical body 72a and a valve seat member 72b. The cylindrical body 72a accommodates the valve element 71. The valve seat member 72b is conically shaped, and is disposed on the upper edge of the cylindrical body 72a. With this structure, the spherical valve element 71 surely makes contact with the conically shaped valve seat member 72b, even though the attitude of the valve element 71 is altered due to fluctuation of fuel level in the sub-tank 20B. When the valve element 71 makes contact with the valve seat member 72b, the ventilation valve 70 closes tightly, as shown in FIG. 4.

The lid member 73 is disposed on the lower edge of the cylindrical body 72a, and prevents the valve element 71 from dropping out of the cylindrical body 72a. The lid member 73 has a protruding portion 74 at a part of the outer periphery thereof. A gap S is formed between the protruding portion 74 and the housing 72.

When the fuel feed apparatus 1B is in operation (when the engine is in operation), fuel in the fuel tank 10 is supplied to the sub-tank 20B by the jet pump 40. At the same time, fuel in the sub-tank 20B is supplied to the engine through the supply pipe 14 with the pump module 30. Generally, the amount of fuel discharging from the jet pump 40 is set more than the maximum amount of fuel supplied to the engine. Accordingly, the sub-tank 20B can be quickly filled with fuel when the fuel feed apparatus 1B is in operation, even though fuel level in the sub-tank 20B fluctuates due to, for example, the alteration of the vehicle attitude.

In the third embodiment, when fuel level in the sub-tank 20B is below the lid member 73 of the ventilation valve 70, the ventilation valve 70 is away from the valve seat member 72b, as depicted with a solid line in FIG. 4. Thus, the inside of the sub-tank 20B is communicated with the outside thereof. In this case, air in the sub-tank 20B passes through the gap S and the cylindrical body 72a of the ventilation valve 70 toward the outside of the sub-tank 20B, and at the same time, the fuel level in the sub-tank 20B rises gradually. When the fuel level in the sub-tank 20B reaches the ventilation valve 70 and the fuel flows into the cylindrical body 72a, the valve element 71 floats on the fuel and moves upward with the rising fuel level. Finally, the valve element 71 makes contact with the valve seat member 72b and the ventilation valve 70 closes tightly, as depicted with a dashed line in FIG. 4. Accordingly, fuel in the sub-tank 20B does not pass through the ventilation valve 70 toward the outside of the sub-tank 20B.

In the third embodiment, when the sub-tank 20B is filled with fuel, fuel in the fuel tank 10 is supplied to the sub-tank 20B by the jet pump 40 as much as the one supplied to the engine by the pump module 30. At the same time, fuel warmed by the heat in the sub-tank 20B does not flow out of the sub-tank 20B because the ventilation valve 70 closes tightly. Accordingly, the fuel feed apparatus 1B can prevent fuel warmed by the heat in the sub-tank 20B from overflowing to the fuel tank 10 so as not to increase the fuel temperature in the fuel tank 10.

Incidentally, the fuel feed apparatus 1B may be installed in a saddle-shaped fuel tank, as described in the second embodiment. In that case, the fuel feed apparatus 1B can prevent fuel warmed by the heat in the sub-tank 20B from overflowing to the saddle-shaped fuel tank so as not to increase fuel temperature in the saddle-shaped fuel tank.

### Fourth Embodiment

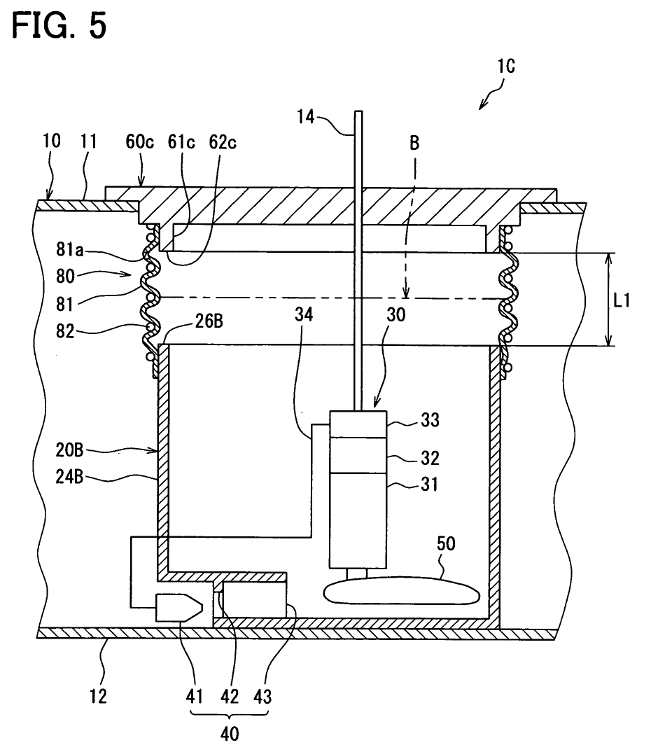

A fuel feed apparatus according to the fourth embodiment will be described with reference to FIG. 5.

As shown in FIG. 5, a fuel feed apparatus 1C does not include a cover and a ventilation valve. Instead, the fuel feed apparatus 1C includes a flexible cover 80 formed as a hollow-cylinder. One end of the flexible cover 80 is fixed on the upper edge 26B of the sub-tank 20B and the other end of the flexible cover 80 is fixed on the flange 60C. The flange 60C has an annular guide member 61C. The guide member 61C protrudes from the flange 60C toward the sub-tank 20B. The other structural features, the sub-tank 20B, the pump module 30, the jet pump 40 and the suction filter 50, are the same as those described in the third embodiment.

The flexible cover 80 includes a diaphragm 81 and a coil spring 82 as an elastic member. The diaphragm 81 is made of flexible material, for example, rubber or resin. Accordingly, the sub-tank 20B can be installed easily at a predetermined position on the bottom wall 12 of the fuel tank 10 when the sub-tank 20B and the flange 60C is disposed in the fuel tank 10. The coil spring 82 is provided coaxially around the diaphragm 81. As shown in FIG. 5, one end of the flexible cover 80 is fixed tightly on the outer periphery of the upper edge 26B of the sub-tank 20B. On the other hand, the other end of the flexible cover 80 is fixed tightly on the outer periphery of the guide member 61C of the flange 60C. Moreover, the one end of the coil spring 82 is fixed on the outer periphery of the sidewall of the sub-tank 20B. And the other end of the coil spring 82 is fixed on the flange 60C. A communication hole 81a is formed at the upper side of the diaphragm 81 near the flange 60C. With this structure, the outside of the flexible cover 80, that is, the inside of the fuel tank 10 is communicated with the inside of the flexible cover 80 only through the communication hole 81a.

The distance L1 between the lower edge 61a of the guide member 61C and the upper edge 26B of the sub-tank 20B when fuel feed apparatus 1C is installed within the fuel tank 10 is shorter than the corresponding distance of the fuel feed apparatus 1C when it is not installed within the fuel tank 10. In other words, when fuel feed apparatus 1C is installed within the fuel tank 10, the coil spring 82 and the diaphragm 81 are compressed so that the sub-tank 20B and the flange 60C are biased apart from each other, as shown in FIG. 5. Accordingly, the sub-tank 20B is held pressed onto the bottom wall 12 of the fuel tank 10 by the force of the coil spring 82.

When the fuel feed apparatus 1C is in operation (when the engine is in operation), fuel in the fuel tank 10 is supplied to the sub-tank 20B by the jet pump 40. At the same time, fuel in the sub-tank 20B is supplied to the engine through the supply pipe 14 by the pump module 30. Generally, the amount of fuel discharging from the jet pump 40 is set more than the maximum amount of fuel supplied to the engine. Accordingly, the sub-tank 20B can be quickly filled with fuel when the fuel feed apparatus 1 is in operation, even though fuel level in the sub-tank 20B fluctuates due to, for example, the alteration of the vehicle attitude.

In the fourth embodiment, when pressure of fuel discharging from the discharge port 43 matches with fuel pressure at the downstream side of the discharge port 43 in the sub-tank 20B, fuel in the sub-tank 20B is balanced and stably maintained at a fuel level B. Even though fuel level B is above the upper edge 26B of the sub-tank 20B, the flexible cover 80 prevents fuel in the sub-tank 20B from flowing out of the sub-tank 20B, e.g., into the fuel tank 10.

In the fourth embodiment, when fuel level in the sub-tank 20B reaches the fuel level B, fuel in the fuel tank 10 is supplied to the sub-tank 20B by the jet pump 40 in an amount corresponding to that supplied to the engine by the pump module 30. At the same time, fuel warmed by the heat in the sub-tank 20B does not flow out of the sub-tank 20B because the flexible cover 80 prevents fuel in the sub-tank 20B from flowing out of the sub-tank 20B. Accordingly, the fuel feed apparatus 1C can prevent fuel warmed by the heat in the sub-tank 20B from overflowing to the fuel tank 10 so that the fuel temperature in the fuel tank 10 is not increased thereby. Moreover, a communication hole 81a is formed at the upper side of the diaphragm 81 near the flange 60C, so that the communication hole 81a is located above the fuel level B.

With this structure, the outside of the flexible cover 80, that is, the inside of the fuel tank 10 is communicated with the inside of the flexible cover 80 only through the communication hole 81a. Air passes through the communication hole 81a between the inside and the outside of the sub-tank 20B. As a result, fuel in the sub-tank 20B is balanced and stably maintained at the fuel level B.

In the fourth embodiment, the sub-tank 20B is held pressed onto the bottom wall 12 of the fuel tank 10 by the force of the coil spring 82 of the flexible cover 80. Therefore, the fuel feed apparatus 1C does not need to have the other members to press the sub-tank 20B onto the bottom wall 12 of the fuel tank 10, for example, the shafts and springs described in the first embodiment.

Incidentally, the fuel feed apparatus 1C may be installed in a saddle-shaped fuel tank, as described in the second embodiment. In that case, the fuel feed apparatus 1C can prevent fuel warmed by the heat in the sub-tank 20B from overflowing to the saddle-shaped fuel tank so as not to increase fuel temperature in the saddle-shaped fuel tank.

### VARIATION

In the above embodiments, the present invention is applied to the fuel feed apparatus for use in an automotive fuel system. However, the present invention is not limited to being applied to a fuel feed apparatus to supply fuel to an engine in an automobile. The present invention may also be applied to a fuel feed apparatus to supply fuel to an engine in another type of vehicle or in stationary electric generators, or to an engine in other similar devices.

The structures described in the above embodiments can be combined as appropriate.

Various other modifications and alternations may be made to the above embodiments without departing from the spirit of the present invention. Thus, while the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A fuel feed apparatus that supplies fuel in a fuel tank to an outside of the fuel tank, the fuel feed apparatus comprising:
a sub-tank that is received in the fuel tank;
a fuel pump that is received in the sub-tank and pumps up and pressurizes fuel in the sub-tank for supplying the fuel to the outside of the fuel tank;
a jet pump disposed to supply fuel in the fuel tank into the sub-tank; and
a recirculation passage that is defined in the sub-tank and communicates between the inside and the outside of the sub-tank;
wherein:
the jet pump includes a suction port to communicate between the inside and the outside of the sub-tank and a jet nozzle that jets fuel toward the suction port, so as to generate suction power by which fuel in the fuel tank is suctioned from the first suction port into the sub-tank; and
the recirculation passage that opens at a lower end thereof close to the upstream side of the suction port of the jet pump and opens at an upper end thereof below the upper edge of a sidewall of the sub-tank.

2. The fuel feed apparatus according to claim 1, wherein:
a partition wall defines the recirculation passage, and
each of the sub-tank and the partition wall is made of resin.

3. The fuel feed apparatus according to claim 2, wherein:
the partition wall is formed integrally with the sub-tank.

4. A fuel feed apparatus that supplies fuel in a fuel tank to an outside of the fuel tank, the fuel feed apparatus comprising:
a sub-tank that is received in the fuel tank;
a fuel pump that is received in the sub-tank and pumps up and pressurizes fuel in the sub-tank for supplying the fuel to the outside of the fuel tank;
a jet pump disposed to supply fuel in the fuel tank into the sub-tank;
a cover that is fixed on the upper edge of the sub-tank to cover the sub-tank hermetically; and
a valve system that is disposed in the cover;
wherein:
the valve closes communication between the inside and the outside of the sub-tank when the sub-tank is filled with fuel.

5. The fuel feed apparatus according to claim 4, wherein:
the valve includes a valve element that is floatable on fuel, a housing that accommodates the valve element so that the valve element can move up and down therein, and a valve seat member that is disposed in the upper side of the housing; and
the valve closes when the valve element makes contact with the valve seat member.

6. The fuel feed apparatus according to claim 5, wherein:
the valve element is formed as a spherical body and is made of material whose specific gravity is lower than that of fuel; and
the valve seat member is conically shaped.

7. The fuel feed apparatus according to claim 4, wherein:
the jet pump includes a suction port to communicate between the inside and the outside of the sub-tank and a jet nozzle that jets fuel toward the suction port, so as to generate suction power by which fuel in the fuel tank is suctioned from the first suction port into the sub-tank;
the fuel pump supplies the pressurized fuel partially to the jet nozzle; and
the jet nozzle jets the fuel supplied from the fuel pump so as to generate suction power.

8. A fuel feed apparatus that supplies fuel in a fuel tank to an outside of the fuel tank, the fuel feed apparatus comprising:
a flange that is mounted on an upper wall of the fuel tank to cover an opening formed in the upper wall;
a sub-tank that is received in the fuel tank and is supported by the flange;
a fuel pump that is received in the sub-tank and pumps up and pressurizes fuel in the sub-tank for supplying the fuel to the outside of the fuel tank;
a jet pump disposed to supply fuel in the fuel tank into the sub-tank through a suction port;
a flexible cover formed as a hollow-cylinder, having one end is fixed on the upper edge of the sub-tank and other end is fixed on the flange; and
a communication hole formed at the upper side of the flexible cover near the flange to communicate between the inside and the outside of the flexible cover.

9. The fuel feed apparatus according to claim 8, wherein:
the flexible cover is compressed so that the sub-tank and the flange are biased apart from each other when the flange is mounted on the upper wall of the fuel tank; and
the sub-tank is held pressed onto a bottom wall of the fuel tank by the force generated by the compressed flexible cover.

10. The fuel feed apparatus according to claim 9, wherein:
the flexible cover includes a diaphragm made of flexible material and a elastic member.

11. The fuel feed apparatus according to claim 8, wherein:
the jet pump includes a suction port to communicate between the inside and the outside of the sub-tank and a jet nozzle that jets fuel toward the suction port, so as to generate suction power by which fuel in the fuel tank is suctioned from the first suction port into the sub-tank;
the fuel pump supplies the pressurized fuel partially to the jet nozzle; and
the jet nozzle jets the fuel supplied from the fuel pump so as to generate suction power.
